(19) United States
(12) Patent Application Publication
(10) Pub. No.: US 2017/0124904 A1
(43) Pub. Date: May 4, 2017

(54) SYSTEM AND METHOD FOR ENABLING A USER TO OVERCOME LOW EMPATHY

(71) Applicants: Jonnalagadda Sasidhar, Sleepy Hollow, NY (US); Manisha Naresh Nagpal, Bangalore (IN); Gowthami Vasudev, Bangalore (IN)

(72) Inventors: Jonnalagadda Sasidhar, Sleepy Hollow, NY (US); Manisha Naresh Nagpal, Bangalore (IN); Gowthami Vasudev, Bangalore (IN)

(73) Assignee: DHARMA LIFE SCIENCES LLC, Sleepy Hollow, NY (US)

(21) Appl. No.: 14/975,885

(22) Filed: Dec. 21, 2015

Related U.S. Application Data
(63) Continuation-in-part of application No. 14/931,868, filed on Nov. 4, 2015.

(51) Int. Cl. G09B 19/00

(52) U.S. Cl. CPC G09B 19/00

(57) ABSTRACT

A system is provided for enabling a user to overcome low empathy. The system is configured to enable the user to engage in a first and a second activity in a virtual environment, directed to rewire a first and a second defective wiring, respectively. The first defective wiring results in an individual's difficulty to read others' social cues. The second defective wiring results in giving exceedingly high priority to self than others. Symptom of the first and the second defective wirings is low empathy. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome low empathy, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, low empathy may be caused by genetic predisposition or excessive sharing of others' negative experiences leading to an emotional burnout or neglectful upbringing or unrealistic over evaluation by others during early life interactions.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a person with low empathy may include inability to understand the emotions of other individuals, interpersonal problems because of their inability to understand the situation from others' perspective and not caring.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome low empathy, which can be classified as a weak personality trait based on the goals of the person.

### SUMMARY

An embodiment provides a system for enabling a user to overcome low empathy. The system includes an activity module. The activity module is configured to enable the user to engage in at least a first activity in a virtual environment. The first activity is directed to rewire a first defective wiring of the brain. The first defective wiring results in an individual's difficulty in reading others' social cues. The activity module is further configured to enable the user to engage in at least a second activity in the virtual environment. The second activity is directed to rewire a second defective wiring of the brain. The second defective wiring results in an individual giving exceedingly high priority to self than others. Symptom of the first and the second defective brain wirings is low empathy. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome low empathy. The method includes enabling the user to engage in at least a first activity in a virtual environment. The first activity is directed to rewire a first defective wiring of the brain. The first defective wiring results in difficulty in reading others' social cues. The user is enabled to engage in at least a second activity in the virtual environment. The second activity is directed to rewire a second defective wiring of the brain. The second defective wiring results in an individual giving exceedingly high priority to self than others. Symptom of the first and the second defective wirings is low empathy. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome low empathy. The system includes an activity module configured to enable the user to engage in at least a first activity in a virtual environment, wherein the first activity is directed to rewire a first defective wiring of the brain, wherein the first defective wiring results in difficulty in reading others' social cues. The activity module is further configured to enable the user to engage in at least a second activity in the virtual environment, wherein the second activity is directed to rewire a second defective wiring of the brain, wherein the second defective wiring results in an individual giving exceedingly high priority to self than others, wherein symptom of the first and the second defective wirings is low empathy, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome low empathy;

FIG. 2 is a block diagram of an exemplary activity module 200 to overcome low empathy;

FIG. 2A is a block diagram of an exemplary behavioral traits database 202 of the activity module 200;

FIG. 2B is a block diagram of an exemplary collection of games 204 present in the activity module 200 to overcome low empathy;

FIG. 2C is a block diagram of an exemplary actions database 206 of the activity module 200 to overcome low empathy; and

FIG. 3 illustrates a flowchart of an exemplary method for overcoming low empathy.

### DETAILED DESCRIPTION

### I. OVERVIEW

### II. PRINCIPLE

### III. SYSTEM ARCHITECTURE

### IV. MODULES OF SYSTEM TO OVERCOME LOW EMPATHY

### V. METHOD FOR OVERCOMING LOW EMPATHY

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome low empathy, which is a weak behavioral trait. The solution is based on a principle that genetic and environmental factors (may be referred to as “cause”) cause defects in human brain wiring (may be referred to as “defect”), and such defects in human brain wiring express themselves in the form of low empathy (may be referred to as “symptoms”); hence, to overcome low empathy, the defective brain wirings have to be rewired, thereby providing a wholesome and long term solution to weak behavioral traits.

In an embodiment, a system is provided to overcome low empathy. The system may include an activity module. The activity module may be configured to enable the user to engage in activities in a virtual environment. The activities in the virtual environment facilitate rewiring of defective brain wirings, wherein the symptom of the defective brain wirings is low empathy. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

As a state of mind, empathy may involve resonating with what is going on in the subjective world of another. In addition to feeling, empathy also involves taking an action to make the other person feel better.

Low empathy is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to low empathy, the brain of the person with low empathy is wired such that the person tends to find difficulty in reading others' social cues, such as facial expressions and body language, among others, which is a defective brain wiring. Additionally, the brain of the person with low empathy is wired such that the individual gives exceedingly high priority to self than others, which is another defective brain wiring. Such defective brain wirings may have been caused by one or more of genetic predisposition. Further, low empathy may be a result of excessive sharing of others' negative experiences leading to an emotional burnout or neglectful upbringing or unrealistic over evaluation by others during early life interactions.

Embodiments provide a solution to rewire the defective brain wirings (addressing the defect) rather than just addressing the behavioral trait (symptom) without addressing the core defect. The solution is directed towards rewiring the defective brain wirings such that the ability to read others' social cues is increased and ability to weigh between self and others and determine who needs to get more priority depending on the situation is increased.

It is important to identify the brain wiring that results in development of a trait. A wholesome approach to overcome, eradicate or alleviate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals with low empathy are unable to read others' social cues (like facial expressions, body language) and they give exceedingly high priority to self rather than others. Different brain regions and neural network of the individual are responsible for such defects. Anterior Insula, Orbito frontal Cortex, Anterior Cingulate Cortex, Ventromedial Prefrontal Cortex, Supramarginal Gyrus and Nucleus Accumbens are important brain regions. Anterior Insula is the region of the brain where feeling of empathy originates. Patients with lesions in this area have a hard time evaluating the emotional state of people in pain and feeling empathetic for them. This region plays an important role in integrating and representing internal and emotional feeling states. This is an important brain area which differentiates between self and others. It is sensory predictive and densely connected with the prefrontal regions. Lower activity is seen in individuals with less empathy. Anterior Cingulate Cortex is an error detection center of the brain. It controls and selects appropriate responses to any environmental stimuli. Anterior Insula and ACC contain a distinctive class of spindle shaped cells called the Von Economo neurons. Their large size and relatively simple dendritic morphology make them suitable for rapid communication allowing a fast integration of global affective states. Orbito Frontal Cortex (OFC) and Nucleus accumbens help reinforce punishment of defectors in social situations. The OFC is important in signaling the expected rewards/punishments of an action. Ventromedial Prefrontal Cortex (VmPFC) plays an important role in regulating and inhibiting responses to emotions in various situations. The VmPFC receives information from the environment and input from dACC. The output of VmPFC controls different physiological responses and behaviors. It's also involved in empathy decision making. Right Supramarginal Gyrus is a part of the cerebral cortex and is approximately located at junction of the parietal, temporal and frontal lobe. It helps a person distinguish his own emotional state from that of another person and is responsible for empathy and compassion. Individuals with less empathy have reduced activity in this region.

When a normal individual faces a situation where he/she has to be empathetic, the sensory information collected by the sensory cortex goes to the anterior insula. The anterior insula along with supramarginal gyrus will weigh if the self has to be given more priority depending on the situation and the emotional salience. After this pattern is decided, the anterior cingulate cortex and the orbito frontal cortex together will weigh the reward against punishment for the same. Then they select and control appropriate responses which are triggered in the nucleus accumbens.

An individual with low empathy has a pattern in which the anterior insula gives more weightage to the self compared to the others. There is low activity in the supramarginal gyrus which does not weigh the emotional valiance of the situation.

### III. System Architecture

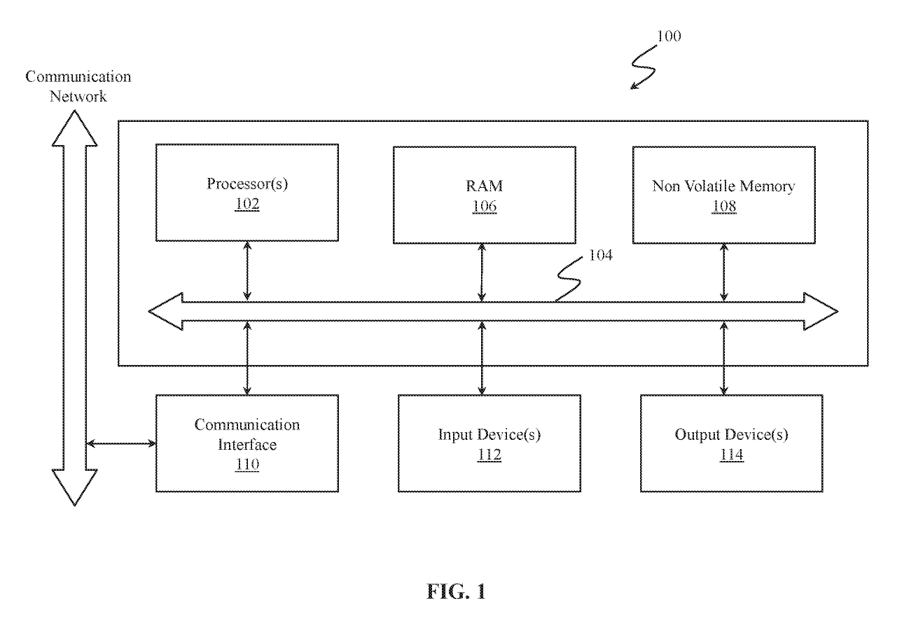

Referring to the figures, more particularly to FIG. 1, an exemplary architecture of an exemplary system 100 to overcome low empathy is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Low Empathy

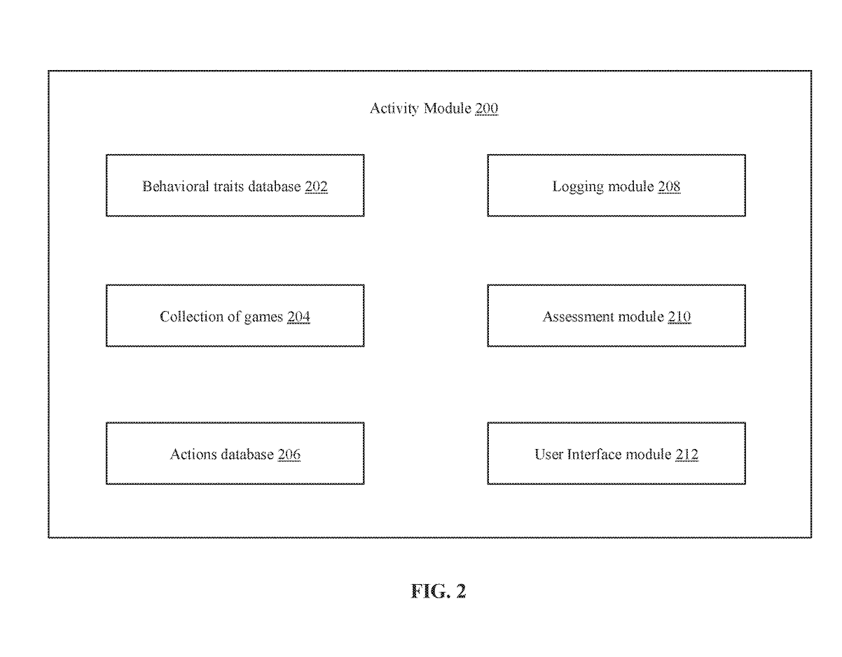

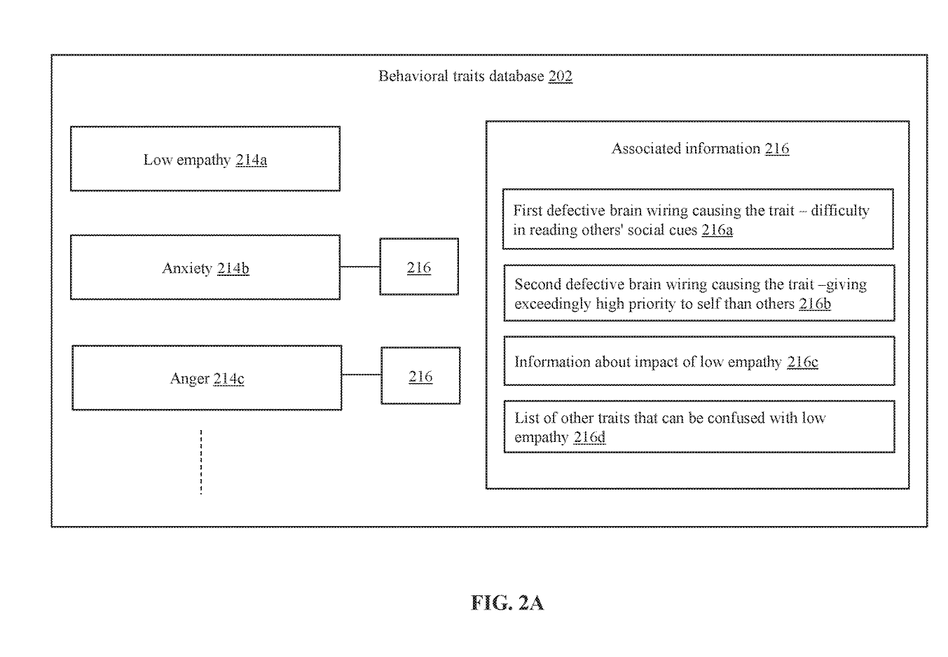

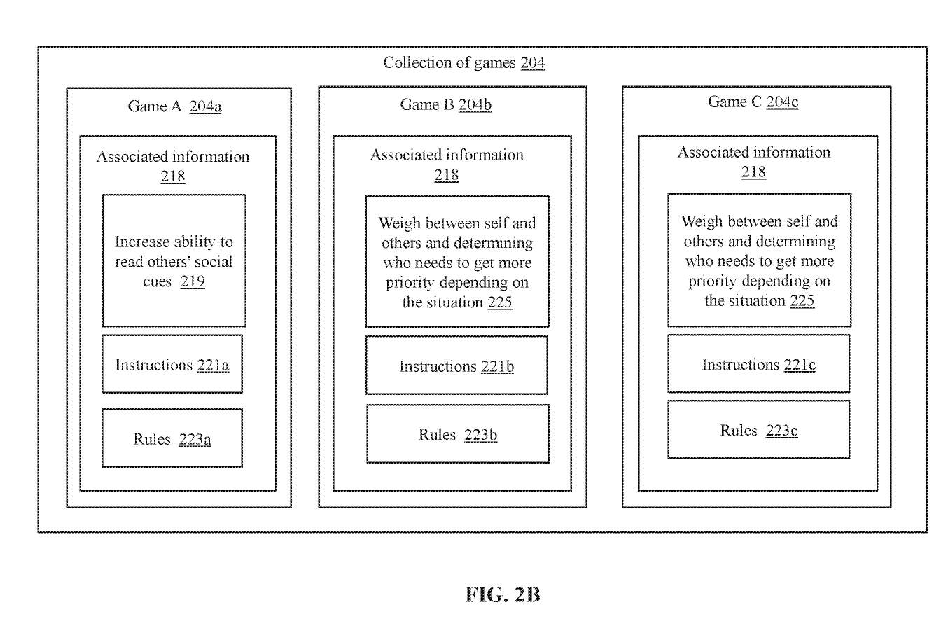

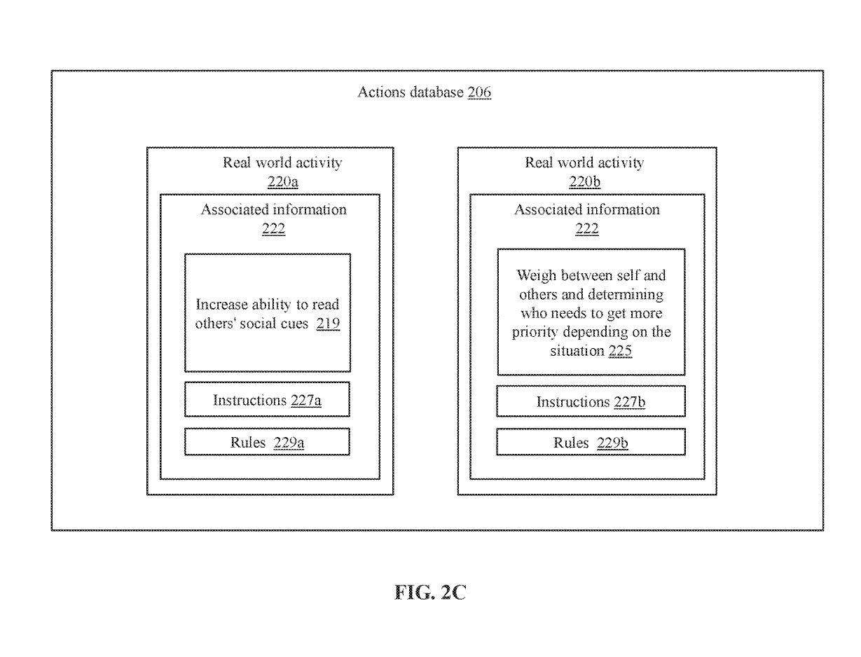

Referring to the figures, and more particularly to FIG. 2, the system 100 includes various modules for enabling users to overcome low empathy. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, low empathy 214a, anxiety 214b and anger 214c, among others. The traits database 202 may further include, with respect to one or more of the behavioral traits, information associated 216 with the trait 214.

With regards to low empathy 214a, the associated information 216 may include information corresponding to the defective brain wirings (defects) 216a, 216b causing low empathy (symptom of the defect), information about impact 216c of low empathy 214a on a person, and a list 216d comprising one or more traits that may be confused with low empathy 214a, among other information. Some or all of the associated information 216 may be displayed to the user of the activity module 200.

A first defective brain wiring 216a causing low empathy 214a is the brain wiring causing difficulty in reading others' social cues (like facial expressions, body language). A second defective brain wiring 216b causing low empathy 214a is the brain wiring causing an individual to give exceedingly high priority to self than others.

In an embodiment, the information corresponding to the first and second defective brain wirings 216a, 216b causing low empathy 214a enable the activity module 200 to select games, activities or actions to overcome low empathy 214a.

In an embodiment, displaying the information corresponding to the defective brain wiring (defect) 216a, 216b causing low empathy 214a helps the user in understanding the defects responsible for low empathy 214a, thereby motivating the user to follow the instructions provided by the activity module 200.

Information about impact 216c of low empathy can include one or more of inability to understand the emotions of other individuals, interpersonal problems because of their inability to understand the situation from others' perspective, arrogance and attitude of not caring.

The list 216d of other traits that can be confused with low empathy 214a include introversion and violence, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome low empathy 214a.

With regards to low empathy 214a, the brain rewiring attempted to achieve to overcome low empathy 214a includes rewiring the defective brain wirings 216a, 216b such that ability to read others' social cues (like facial expressions, body language) is increased and ability to weigh between self and others and determining who needs to get more priority depending on the situation is increased.

In an embodiment, the activity module 200 may display the information corresponding to the causes (genetic or environmental) that resulted in the defective brain wirings (defect) 216a, 216b, which in turn resulted in low empathy 214a, thereby enabling the user to relate to the cause, defect and symptom of the defect, which results in a wholesome experience while working to overcome low empathy 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204c (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, three different games 204a-204c are included in the collection of games 204. The three games 204a, 204b and 204c can be used by the activity module 200 to correct the defective brain wirings 216a and 216b by rewiring the brain to increase the ability to read others' social cues 219 and increase ability to weigh between self and others and determine who needs to get more priority depending on the situation 225.

Game A 204a is directed at rewiring 219 the brain to increase the ability to read others' social cues (like facial expressions, body language). The games, 204b and 204c are directed at rewiring 225 the brain to increase the ability to weigh between self and others and determine who needs to get more priority depending on the situation.

Game A 204a may be designed to rewire the brain to increase the ability to read others' social cues 219. The game 204a may be developed to exercise the social cognition network in an individual's brain. It has been designed to improve how one's brain processes social input, so that one can correctly interpret facial expressions and body language. The instruction 221a may include recommendation to play the game 204a for a minimum of fifteen minutes every day, as an example. The rules 223a may allow proceeding to a next level in the game 204a once a desired level of performance is achieved.

In a first level, the user is shown a face. The user has to decide what expression the user thinks the face indicates. The user will see a set of choices of emotions and they have to choose the word showing the same expression as the face that they saw. The user has to play this level for 15 mins everyday to get to the next level of the game, as an example. Examples of emotions which could be shown may include neutral, happy, sad, fearful, angry, surprised, disgusted, happily surprised, happily disgusted, sadly fearful, sadly angry, sadly surprised, sadly disgusted, fearfully angry, fearfully surprised, fearfully disgusted, angrily surprised, angrily disgusted, disgustedly surprised, appalled, hatred, and awed, among others.

In a second level, a picture of a person exhibiting a particular body language may be shown. The user has to decide the meaning of that body language. The user will see a set of choices and they have to choose the one describing the body language which was shown. The user has to play this level for 15 mins every day, as an example. A list of body language and associated meaning are provided in Table 1 as an example:

TABLE 1

| Body Language | Meaning |
|---|---|
| Brisk, erect walk | Confidence |
| Standing with hands on hips | Readiness, aggression |
| Sitting with legs crossed, foot | Boredom |
| kicking slightly | |
| Sitting, legs apart | Open, relaxed |
| Arms crossed on chest | Defensiveness |
| Walking with hands in pockets, | Dejection |
| shoulders hunched | |
| Hand to cheek | Evaluation, thinking |
| Touching, slightly rubbing nose | Rejection, doubt, lying |
| Rubbing the eye | Doubt, disbelief |
| Hands clasped behind back | Anger, frustration, apprehension |
| Locked ankles | Apprehension |
| Head resting in hand, eyes | Boredom |
| downcast | |
| Rubbing hands | Anticipation |
| Sitting with hands clasped behind | Confidence, superiority |
| head, legs crossed | |
| Open palm | Sincerity, openness, innocence |
| Pinching bridge of nose, eyes | Negative evaluation |
| closed | |
| Tapping or drumming fingers | Impatience |
| Steepling fingers | Authoritative |
| Patting/fondling hair | Lack of self-confidence; |
| | insecurity |
| Quickly tilted head | Interest |
| Stroking chin | Trying to make a decision |
| Looking down, face turned away | Disbelief |
| Biting nails | Insecurity, nervousness |
| Pulling or tugging at ear | Indecision |
| Prolonged tilted head | Boredom |

In a third level, an audio of a person saying a sentence will be played. The user has to interpret the emotion that the person in the audio is feeling. The user will see a set of choices and they have to choose the one describing the emotion which was displayed in the audio. The user has to play this level for 15 mins every day, as an example.

In a fourth level, only the eyes of a person displaying an emotion will be shown. The user has to interpret the emotion that the person in the picture is feeling. The user will see a set of choices and they have to choose the one describing the emotion which was displayed. The user has to play this level for 15 mins every day, as an example. Information on level 4 may be available online.

In a fifth level, at least five people are shown who display different emotions. Each time the picture changes the user has to answer one or more of the following questions:
The happiest person in the picture
The person who seems most upset
Worried person in the picture
Individual who is surprised
The person who needs help

Game B 204b may be designed to enhance one's ability to weigh between self and others and determine who needs to get more priority depending on the situation 225. The instruction 221b may include recommendation to play the game 204b for at least a predefined duration for a predefined number of days. The rules 223b may allow proceeding to a next level in the game 204b once a desired level of performance is achieved.

In Game B 204b, a situation/event may be presented to the user. The user has to choose a correct answer based on a choice of facts provided that is related to the situation/event. One example is presented below:

### Situation/Event:

A colleague had a break up

### True Facts:

She is a good friend
You have a lot of work
She is very upset and is crying
She helped you in the past
   You would give more importance to:
Self
Your friend
   Correct answer: Friend
   Game C 204c may be designed to enhance one's ability to weigh between self and others and determine who needs to get more priority depending on the situation 225. The game may be developed to be played by two players simultaneously. As an example, one of the players may be the individual with low empathy and the other player may be his/her friend. The instruction 221c may include recommendation to play the game 204c where the players have to reach the end line having at least a minimum amount of energy left and within particular time duration. During the game, the individual is given control of his own moves as well as his friend's moves and similarly such control may be assigned to the other player as well. Further, the friend may take control when the individual with low empathy keeps proving to be less empathetic towards his friend (as an example, when the user makes his friend get hurt). That should be made clear so that the user will know when it is his chance to take control of the game and play it. The game will have hurdles where the user will be allowed to go up, down, right or left depending on the type of hurdle. The user has to make sure that he crosses all the hurdles with maximum energy along with his friend. Examples of hurdles include branches, rivers and so on. The player should also find food, other energy packets to increase his energy level and the friend's. The rules 223c may allow proceeding to a next level in the game 204c once a desired level of performance is achieved.

In a first level, the number of hurdles will be less and the hurdles do not coincide between players, such that both of the players should not get a hurdle at the same time.

In a second level, the number of hurdles may be more and the hurdles sometimes coincide, such that both the players get a hurdle at the same time, and the individual needs to choose who to save by weighing who has more energy and who will get more hurt. The user should choose to jump in favor of that player who has low energy and who will get more hurt (thereby being more empathetic). The energy should automatically reduce depending on the type of hurdle.

A third level of game C 204c may be similar to the second level, with a few details altered where the user can give or take the energy of his/her friend and there is a conflict between whether to save the friend or stop and collect the energy packet and vice versa.

A fourth level may be similar to the third level, except for a change where a monster runs behind the players, and if anyone's energy is low or fails to jump then the monster will eat the player.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b or sets of real world activities 220a-220b (may be referred by numeral 220) is used by the activity module 200 based on the brain rewiring 219, 225, which the real world activity 220 is capable of achieving.

Each real world activity 220 may include associated information 222. As an example, a real world activity may be capable of achieving more than one type of brain rewiring. Each real world activity 220 includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others.

The real world activity 220a may be presented to the user after the user has at least participated in one or more games to a predefined extent that attempts to rewire 219 the first defective brain wiring 216a. The real world activity 220a may be designed to rewire the brain to increase the ability to read others' social cues (e.g. facial expressions and body language).

In a first level, the activity module 200 may provide instructions 227a, to observe at least five people and interpret their emotional state by looking at their facial expressions and eyes. The activity module 200 may further instruct the user to write down the names of those people he/she observed and the emotions they felt, at the end of the day. A box may be provided by the activity module 200 for the user to provide his response. This activity 220a would help the user in understanding others better and respond/communicate effectively with them.

In a second level the activity module 200 may provide instructions 227a to observe at least two people and interpret their body language. The activity module 200 may further instruct the user to write down the names of those people he/she observed and what their body language communicated, at the end of the day. A box may be provided by the activity module 200 for the user to provide his response. This activity 220a would help a user in understanding other people better and respond/communicate effectively with them.

In a third level, the activity module 200 may provide instructions 227a to pay attention to the tone of the voice of the person speaking to them over phone and interpret what they are feeling. Further instructions 227a may be provided to write down the names of those people the user spoke to and what they felt, at the end of the day. A box may be provided by the activity module 200 for the user to provide his response.

The real world activity 220b may be presented to the user after the user has at least participated in one or more games to a predefined extent that attempts to rewire 225 the second defective brain wiring 216b. The real world activity 220b may be designed to rewire the brain to increase the ability to weigh between self and others and determine who needs to get more priority depending on the situation 225.

In a first level, instructions 227b may be provided by the activity module 200 to observe the people the user interacts with and find out if anyone is upset/worried or is undergoing any difficult situation in their life. If anyone is upset/worried or undergoing any difficult situation in their life then the user may be required to go ahead and talk to the person, comfort them and help them out if possible.

In a second level, instructions 227b may be provided by the activity module to visit an NGO that serves orphans, old age homes or differently abled on weekends or whenever the user finds free time. The user can spend time with the individuals there, share their concerns and help them in the smallest way possible.

In an embodiment, the action database 206 further includes plurality of physical actions, mind actions and dietary actions, one or more of which may be presented to a user who is trying to overcome low empathy 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Low Empathy

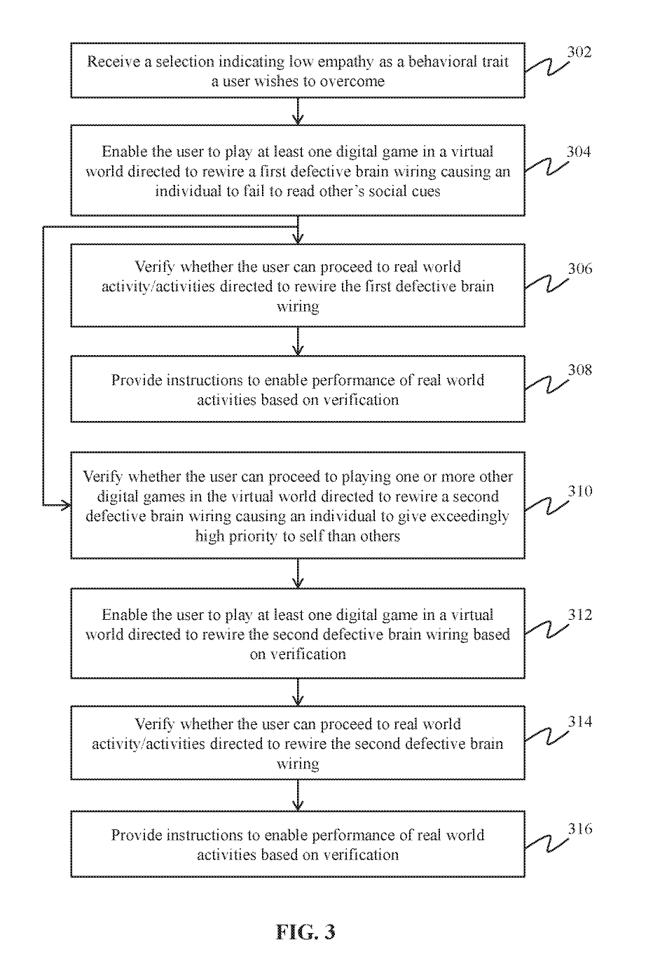

Now referring more particularly to FIG. 3, a method is provided for overcoming low empathy 214a. A selection indicating low empathy 214a as a behavioral trait which a user wishes to overcome is received at step 302. At step 304, a user is enabled to participate/play in at least one digital game 204a which is played in a virtual world. The digital game 204a is instrumental in rewiring 219 a first defective brain wiring 216a, whose symptom is exhibition of low empathy 214a. At step 306, verification is made to determine whether the user can proceed to perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in the digital game 204a at least to a predefined extent, which is determined based on the desired rewiring. The real world activity 220a is instrumental in rewiring 219 the first defective brain wiring 216a, whose symptom is exhibition of low empathy 214a.

At step 310, verification is made to determine whether the user can proceed to playing at least one or more other digital games 204b and 204c in the virtual world directed to rewire a second defective brain wiring 216b causing an individual to give exceedingly high priority to self than others. In case it is determined that user can proceed, then at step 312 the user is enabled to participate/play digital games 204b and/or 204c, which is played in a virtual world. The digital games 204b-204c are instrumental in rewiring 225 the second defective brain wiring 216b, whose symptom is exhibition of low empathy 214a. Preferably, the user is allowed to proceed to playing at least one or more other digital games 204b and 204c upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in the digital game(s) 204b/204c at least to a predefined extent, which is determined based on the desired rewiring. The real world activity 220b is instrumental in rewiring 225 the second defective brain wiring 216b, whose symptom is exhibition of low empathy 214a.

In an embodiment, the user may be instructed to perform real world activity/activities 220b instrumental in rewiring 225 the second defective wiring 216b, after the user has participated in digital game 204b at least to an extent. In another embodiment, instruction may be provided to perform real world activity/activities 220b instrumental in rewiring 225 the second defective wiring 216b, after the user has participated in digital game 204c at least to an extent. In yet another embodiment, real world activity/activities 220b instrumental in rewiring 225 the second defective wiring 216b, may be instructed to be performed after the user has played each digital game 204b and 204c at least to an extent.

Referring to the step (302) of receiving a selection indicating low empathy 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of low empathy 214a, the activity module 200 may display a list 216d of other behavioral traits that can be confused with low empathy 214a, so that the user can select a more appropriate behavioral trait 214, which he desires to work on. The activity module 200 may further display the information corresponding to the brain wirings (defect) 216a, 216b causing the trait behavioral 214. The first defective brain wiring 216a causes difficulty in reading others' social cues. The second defective brain wiring 216b causes exceedingly high prioritization to self over others.

The activity module 200 may additionally display information about impact 216c of low empathy 214a to the user. In addition, the activity module 200 may display information corresponding to the brain rewiring 219, 225 that the activity module 200 is attempting to achieve to overcome low empathy 214a. Rewiring 219 of the first defective brain wiring 216a results in increased ability to read others' social cues. Rewiring 225 of the second defective brain wiring 216b results in increased ability to weigh between self and others and determine who needs to get more priority depending on the situation.

Furthermore, the activity module 200 may display the information corresponding to the causes (genetic or environmental) that resulted in the defective brain wirings (defect) 216a, 216b.

Referring to the step (304) of enabling the user to play at least one digital game in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220a. Preferably, the activity module 200 recommends real world activities 220a after the user has performed to a desired extent in the digital game(s) 204. Desired extent of performance can be, as an example, levels completed, score reached and duration over which the game 204 was played.

In an embodiment, the activity module 200 recommends (step 308) participating in real world activity 220a or a part thereof, after the user has performed to a desired extent in the digital game 204a. Likewise, the activity module 200 may recommend participating in the real world activity 220b or a part thereof, after the user has performed to a desired extent in the digital game 204b and/or 204c. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing at least one or more other digital games in the virtual world directed to rewire the second defective brain wiring 216b causing an individual to give exceedingly high priority to self than others. Rewiring the second defective brain wiring 216b results in ability to weigh between self and others and determine who needs to get more priority depending on the situation.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and real world activity/activities directed to rewire the first defective brain wiring 216a.

The activity module 200, based on the verification, enables (step 312) the user to play/participate in at least one other digital game 204b-204c in the virtual world directed to rewire the second defective brain wiring.

Referring to step 314, the activity module 200 verifies whether the user can proceed to real world activity/activities 220b directed to rewire 225 the second defective brain wiring 216b. In an embodiment, the activity module 200 recommends (steps 314, 316) participating in real world activity 220b or part thereof after the user has performed to a desired extent in the digital game 204b. In another embodiment, the activity module 200 recommends participating in real world activity 220b or part thereof after the user has performed to a desired extent in the digital game 204c.

In another embodiment, the activity module 200 recommends participating in digital game 204b after the user has performed to a desired extent in a level of the digital game 204a. Similarly, the activity module 200 recommends participating in digital game 204c after the user has performed to a desired extent in a level of the digital game 204b.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting low empathy, the activity module 200 provides a scale operable by the user to select a position on the scale. The position may be indicative of the user's perception of how empathetic he is. Improvement in low empathy resulting from the rewiring of the brain achieved by the performance of the activities (virtual games or real world activities) enabled by the activity module 200 is reflected on the scale. Degradation of the improvement in empathy resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome low empathy, the system comprising an activity module configured to:
enable the user to engage in at least a first activity in a virtual environment, wherein the first activity is directed to rewire a first defective wiring of the brain, wherein the first defective wiring results in difficulty in reading others' social cues;
enable the user to engage in at least a second activity in the virtual environment, wherein the second activity is directed to rewire a second defective wiring of the brain, wherein the second defective wiring results in giving exceedingly high priority to self than others, wherein symptom of the first and the second defective wirings is low empathy;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity after the user has at least participated in the first activity.

6. A method for enabling a user to overcome low empathy, the method comprising:
enabling the user to engage in at least a first activity in a virtual environment, wherein the first activity is directed to rewire a first defective wiring of the brain, wherein the first defective wiring results in difficulty in reading others' social cues;
enabling the user to engage in at least a second activity in the virtual environment, wherein the second activity is directed to rewire a second defective wiring of the brain, wherein the second defective wiring results in an individual giving exceedingly high priority to self than others, wherein symptom of the first and the second defective wirings is low empathy;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity after the user has at least participated in the first activity.

11. A system for enabling a user to overcome low empathy, the system comprising an activity module configured to:
enable the user to engage in at least a first activity in a virtual environment, wherein the first activity is directed to rewire a first defective wiring of the brain, wherein the first defective wiring results in difficulty in reading others' social cues; and
enable the user to engage in at least a second activity in the virtual environment, wherein the second activity is directed to rewire a second defective wiring of the brain, wherein the second defective wiring results in an individual giving exceedingly high priority to self than others, wherein symptom of the first and the second defective wirings is low empathy, wherein engagement in the second activity is enabled after the user has at least participated in the first activity.

12. The system of claim 11, wherein,
the first activity is directed to rewire the first defective wiring to increase the ability to read others' social cues; and
the second activity is directed to rewire the second defective wiring to increase the ability to weigh between self and others and determine who needs to get more priority depending on the situation.
